(19) United States
(12) Patent Application Publication
(10) Pub. No.: US 2006/0007122 A1
(43) Pub. Date: Jan. 12, 2006

(54) Method of controlling cursor by mobile communication device

(75) Inventors: Cheng-Shing Lai, Taipei Hsien (TW); Bin Zhang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/859,191

(22) Filed: Jun. 3, 2004

(51) Int. Cl. G09G 5/00

(52) U.S. Cl. 345/156

(57) ABSTRACT

The present invention discloses a method of controlling a cursor by a mobile communication device, which uses a video grabber to capture a plurality of moving images according to the moving track of the mobile communication device. The moving images are sent to a video processing unit installed in the mobile communication device for an analysis to produce a cursor control signal, and then the cursor control signal is sent to a computer for controlling the cursor of the computer by a signal transmitter of the mobile communication device.

### FIELD OF THE INVENTION

The present invention relates to a method of controlling a cursor, more particularly to a method of controlling a cursor by a mobile communication device, which uses a video grabber to capture a plurality of moving images according to the moving track of the mobile communication device and send the moving images to a video processing unit installed therein for calculating the moving distances and directions of the moving images and achieving the function of an ordinary optical mouse.

### BACKGROUND OF THE INVENTION

In recent years, the blooming electronics industry provides more and more functions to various electronic products and the selling price becomes lower and lower. The common mobile phone and personal digital assistant are examples of these electronic products. As the technology of the electronics industry advances, the electronic products tend to be developed in a light, thin, short, and compact fashion, which has become a common trend for modern electronic telecommunication devices. The specifications for their functions and applications are upgraded continuously to fully meet consumer's requirements. As to the electronic product manufacturers, whether or not the manufacturer can minimize the cost to produce a product with a maximum number of functions or outstanding functions to meet consumer's requirements is an important index for evaluating the technological level of such manufacturer.

For mobile phones and notebook computers, both have powerful telecommunication and computational functions, and their size is small and portable, which make them a necessary tool for modern businessmen or people on a business trip. For instance, a video grabber is installed in a mobile phone or a notebook computer, so that the mobile phone or the notebook computer can use the video grabber to capture dynamic images continuously or capture a static image, and then send the dynamic images or the static image to another mobile phone or notebook computer at a remote site through a network (such as a telecommunication network or Internet), and users can view the dynamic images or the static image on the mobile phone or notebook computer at the other end. Such transmission is no longer restricted to the text or the sound only. Therefore, businessmen or people on a business trip can send the pictures of customer's samples back to the company or transmit the pictures of the company's products for the view of the customers and thus improving the efficiency of their work.

The design of such built-in video grabber is common in mobile phones such as the Nokia 7650 and 6820 or the Sony Z600 and P800 or the Samsung E715 as well as in notebook computers such as the Sony PCG-TR1T and PCG-TR2T.

Further, notebook computers are restricted by the specification of compact size, notebook computers generally come with a touch pad or a pointing stick for controlling the moving direction of a cursor on a screen display by operating the touch pad or the pointing stick. However, the control for moving a cursor by the touch pad or the pointing stick is not as convenient as a mechanical mouse or an optical mouse. Therefore, it is common for users to install an external mechanical mouse or optical mouse via a port (such as a USB port or a PS/2 port).

However, it is inconvenient or will increase the user's burden to carry an additional mechanical mouse or an optical mouse with them, and thus a feasible solution is urgently needed to solve such issue.

### SUMMARY OF THE INVENTION

In view of the shortcomings of the prior arts, the inventor of the present invention conducted extensive researches and experiments and finally developed a method of controlling a cursor by a mobile communication device.

The primary objective of the present invention is to provide a method of controlling a cursor by a mobile communication device, which uses a video grabber to capture a plurality of moving images according to the moving track of the mobile communication device. The moving images are sent to a video processing unit installed in the mobile communication device for an analysis to produce a cursor control signal, and then the cursor control signal is sent to a computer for controlling the cursor of the computer by a signal transmitter of the mobile communication device.

The above and other objects, features and advantages of the present invention will become apparent from the following detailed description taken with the accompanying drawings.

### BRIEF DESCRIPTION OF THE DRAWINGS

FIG. 1 is a block diagram of the structure of the present invention.

FIG. 2 is a flow chart of controlling the cursor according to the present invention.

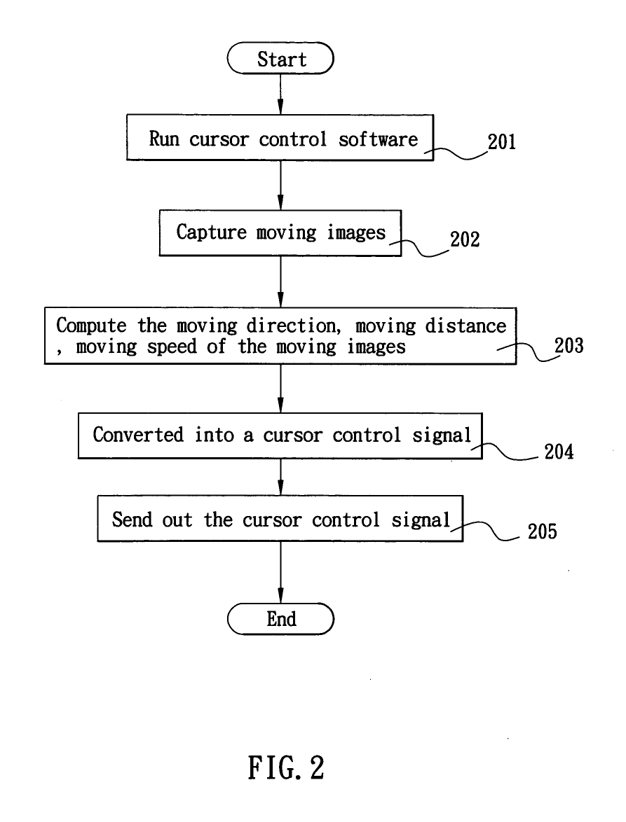

FIG. 3 is a flow chart of transmitting signals according to the present invention.

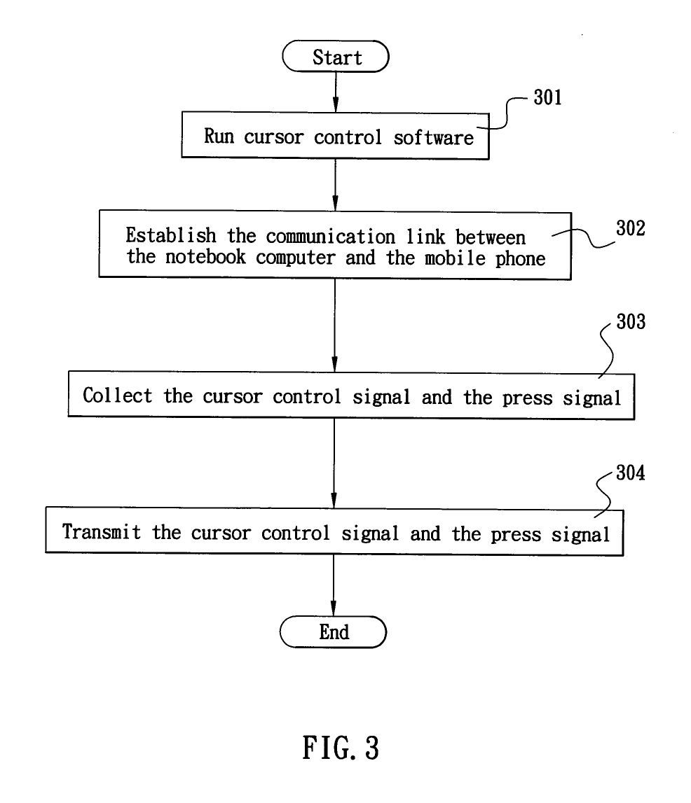

### DETAILED DESCRIPTION OF THE PREFERRED EMBODIMENTS

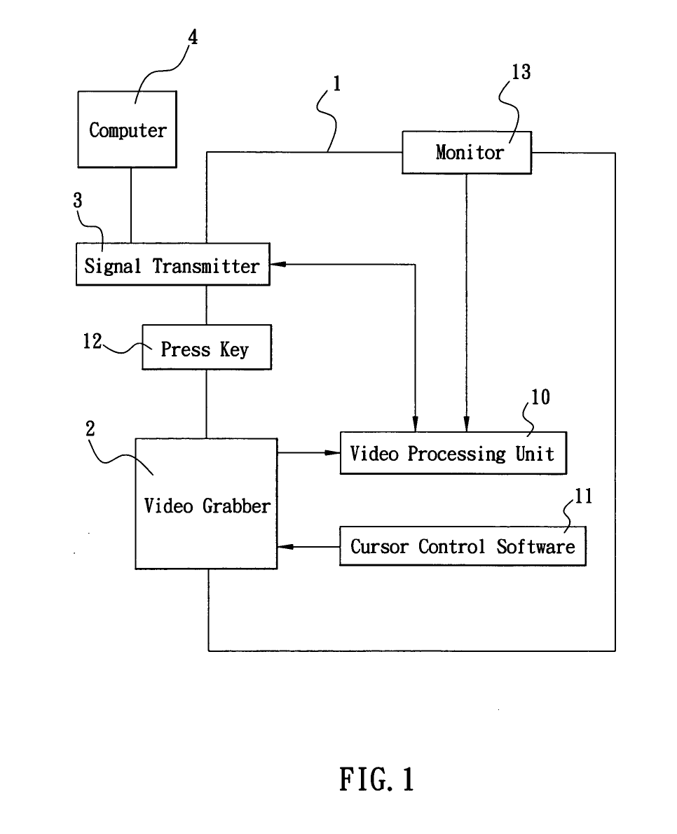

Please refer to FIG. 1 for the method of controlling a cursor by a mobile communication device. The mobile communication device 1 comprises a video grabber 2 (such as a charge-coupled device, CCD) and a signal transmitter 3 on the surface of the mobile communication device 1; a video processing unit 10 and a cursor control software 11. If the cursor control software 11 is run, the video grabber 2 will capture a plurality of moving images according to the moving track of the mobile communication device 1, and the moving images will be sent to the video processing unit 10 for an analysis to produce a cursor control signal corresponding to the moving track. The cursor control signal is sent out from the signal transmitter 3. If the signal transmitter 3 is connected to a notebook computer 4, then the cursor control signal will be received by the notebook computer 4 for controlling the cursor of the notebook computer 4.

To further understand how the mobile communication device 1 controls the cursor, the procedure of controlling the cursor by the mobile communication device 1 comprises the steps of.

(201) starting a cursor control software 11 to turn on a video grabber;

(202) capturing a plurality of moving images by the video grabber 2 according to the moving track of the mobile communication device 1 and sending the moving images to a video processing unit 10;

(203) computing the moving direction, moving distance, and moving speed of the moving track from the moving images by the video processing unit 10;

(204) converting the moving direction, moving distance, and moving speed into a cursor control signal by the video processing unit 10, and sending the cursor control signal to a signal transmitter 3; and

(205) sending out the cursor control signal by the signal transmitter 3.

In a preferred embodiment of the present invention, the mobile communication device 1 is a mobile phone; the signal transmitter 3 is a universal serial bus (USB) installed on the mobile phone; the video processing unit 10 is a graphic identification chip or a graphic identification software installed in the mobile phone, so that after the cursor control software 11 is executed, any two press keys 12 disposed on the mobile phone are set as the left and right buttons of the mouse. The press keys of the mobile phone serve the same function as the left and right buttons of a mouse. The universal serial bus of the mobile phone is connected to the universal serial bus of a notebook computer 4, so that the press signal sent by the press key of the mobile phone and the cursor control signal are sent to the notebook computer 4 for controlling the cursor of the notebook computer 4.

In this embodiment, the video grabber 2 makes use of an optical imaging principle to move the moving track of the mobile phone in the up, down, left, or right directions to produce a series of moving screens. These moving screens are recorded as a plurality of moving images, and the moving images are sent to the video processing unit 10 for an analysis to produce the cursor control signal and control the cursor of the notebook computer 4.

Further, since the graphic identification chip or the graphic identification software receives a plurality of moving images, but the graphic identification chip or the graphic identification software cannot use the infrared reflection theory of an optical module to obtain the moving direction and the moving distance, therefore the graphic identification chip or the graphic identification software according to this embodiment selects at least one feature area from the moving images, and then selects at least one feature point from the feature areas as an analytical data for the graphic identification, so that the graphic identification chip or the graphic identification software can use its built-in graphic identification computation procedure to compute the moving direction, moving distance, and moving speed of the moving images and convert the moving direction, moving distance, and moving speed of the moving images into a cursor control signal for controlling the cursor.

To facilitate the successful signal transmission between the mobile phone and the notebook computer, the mobile phone and the notebook computer according to this embodiment comprises an object exchange protocol (OBEX), so that after the universal serial bus of the mobile phone is connected with the universal serial bus of the notebook computer 4, the procedure of the signal transmission between the mobile phone and the notebook computer 4 comprises the steps of:

(301) starting a cursor control software 11;

(302) using an object exchange protocol to set the notebook computer 4 as a server and the mobile phone as a client to establish a communication link between the notebook computer 4 and the mobile phone;

(303) using an object exchange protocol to collect the cursor control signal and the press signal from the press keys by the mobile phone; and

(304) transmitting the cursor control signal and the press signal through the universal serial bus of the mobile phone.

By using a mobile phone to control a mouse, businessmen or people on a business trip do not need to carry an additional mechanical mouse or optical mouse if they carry the notebook computer 4 and the mobile phone with them. The present invention can achieve the effect of using a mobile phone to obtain the function equivalent to a mechanical mouse or an optical mouse to reduce the user's burden.

While the invention has been described by means of specific embodiments, numerous modifications and variations could be made thereto by those skilled in the art without departing from the scope and spirit of the invention set forth in the claims.

What is claimed is:

1. A method of controlling cursor by mobile communication device, including a video grabber and a signal transmitter disposed on the surface of a mobile communication device, and said mobile communication device being processed according to the steps of:
starting a cursor control software to turn on a video grabber;
capturing a plurality of moving images by said video grabber according to a moving track of said mobile communication device and sending said moving images to a video processing unit;
computing a moving direction, a moving distance, and a moving speed of said moving track from said moving images by said video processing unit;
converting said moving direction, moving distance, and moving speed into a cursor control signal by said video processing unit, and sending said cursor control signal to a signal transmitter; and
sending out said cursor control signal by said signal transmitter.

2. The method of controlling cursor by mobile communication device of claim 1, wherein said mobile communication device is a mobile phone, such that after said cursor control program is run, two of the press keys of said mobile phone are set as the left and right buttons of a mouse.

3. The method of controlling cursor by mobile communication device of claim 2, wherein said signal transmitter comprises a universal serial bus installed in said mobile phone, and a universal serial bus of said mobile phone is connected to a universal serial bus of a computer, so that a press signal sent from said press keys of said mobile pone and said cursor control signal are sent to said computer.

4. The method of controlling cursor by mobile communication device of claim 3, wherein said mobile phone comprises an object exchange protocol, such that after said universal serial bus of said mobile phone is connected to said universal serial bus of said computer, the procedure of a signal transmission between said mobile phone and said computer comprises the steps of:
starting a cursor control software;
using an object exchange protocol to set said notebook computer as a server and said mobile phone as a client to establish a communication link between said notebook computer and said mobile phone;
using an object exchange protocol to collect said cursor control signal and said press signal from said press keys by said mobile phone; and
transmitting said cursor control signal and said press signal through said universal serial bus of said mobile phone.

5. The method of controlling cursor by mobile communication device of claim 3, wherein said video grabber uses an image formation principle to display a moving track of moving selectively in the up, down, left and right directions on a screen display of said mobile phone, and produce a series of moving screens, and said moving screens are recorded into a plurality of moving images, and said moving images are sent to said video processing unit for an analysis to produce said cursor control signal and control a cursor on said computer.

6. The method of controlling cursor by mobile communication device of claim 5, wherein said video processing unit is a graphic identification chip, which selects at least one feature area from said moving images, and then selects at least one feature point from said feature areas as an analytical data for a graphic identification, so that said graphic identification chip uses a graphic identification computing process built in said graphic identification chip to compute said moving direction, moving distance, and moving speed of said moving images and convert said moving direction, moving distance, and moving speed into said cursor control signal for controlling said cursor.

7. The method of controlling cursor by mobile communication device of claim 5, wherein said video processing unit is a graphic identification software, which selects at least one feature area from said moving images, and then selects at least one feature point from said feature areas as an analytical data for a graphic identification, so that said graphic identification chip uses a graphic identification computing process built in said graphic identification chip to compute said moving direction, moving distance, and moving speed of said moving images and convert said moving direction, moving distance, and moving speed into said cursor control signal for controlling said cursor.
